(19) United States
(12) Patent Application Publication
(10) Pub. No.: US 2003/0210793 A1
(43) Pub. Date: Nov. 13, 2003

(54) External input audio processor

(76) Inventor: Tetsuya Hara, Tokyo (JP)

Correspondence Address: BURNS, DOANE, SWECKER & MATHIS, L.L.P., P.O. Box 1404, Alexandria, VA, 22313-1404, US

(21) Appl. No.: 10/272,917

(22) Filed: Oct. 18, 2002

(30) Foreign Application Priority Data
May 8, 2002 (JP) 2002-132975

(51) Int. Cl. H04R 5/00; H04R 5/02

(52) U.S. Cl. 381/22; 381/307

(57) ABSTRACT

An external input audio processor includes an input terminal for inputting an audio stream, an input terminal for inputting an audio serial data, an input terminal for inputting digital data obtained by analog-to-digital conversion of an analog input, an input terminal for inputting external digital audio data, a selector for selecting one of the digital data supplied from the four input terminals, and an audio processing circuit for carrying out audio processing of the digital data selected by the selector. The external input audio processor can reduce the circuit scale of the system.

### BACKGROUND OF THE INVENTION

1. Field of the Invention

The present invention relates to an external input audio processor.

2. Description of Related Art

FIG. 8 is a block diagram showing a configuration of a conventional DVD system with built-in external input audio processor. In this figure, the reference numeral 1 designates a DVD (Digital Video Disc), 2 designates a DVD system and 3 designates a speaker.

In the DVD system 2, the reference numeral 4 designates a disc loader that reads data from the DVD 1 and converts the data to an audio stream to be output, or reads data from a CD (Compact Disc) and converts the data to audio serial data to be output; 5 designates an audio ADC (Analog-to-Digital Converter) that carries out analog-to-digital conversion of an analog input and outputs digital data; 6 designates a DIR (Digital Interface Receiver) for carrying out format conversion of external digital audio data such as an IEC958 input; and 7 designates a selector that selects one of the audio serial data, digital data and digital audio data passing through the format conversion by the DIR 6, and outputs the selected one.

The reference numeral 8 designates a DVD decoder (external input audio processor) consisting of a semiconductor chip for isolating the stream read from the DVD 1 and supplied from the disc loader 4, and for carrying out the image decoding and sound decoding of the stream. In the DVD decoder 8, the reference numeral 9 designates a selector for selecting one of the digital data supplied from the disc loader 4 and the selector 7; and 10 designates an audio processing circuit for carrying out audio processing of the digital data selected by the selector 9.

The reference numeral 11 designates an audio DAC (Digital-to-Analog Converter) that carries out the digital-to-analog conversion of the digital data passing through the audio processing, and supplies the analog data to the speaker 3.

Next, the operation of the conventional DVD system will be described.

In FIG. 8, the stream on the DVD 1 or video CD is read by the disc loader 4 and supplied to the DVD decoder 8. The DVD decoder 8 isolates the stream to undergo the image decoding and sound decoding. The decoded data is subjected to the analog conversion by the audio DAC 11, and output from the speaker 3.

On the other hand, the data of the CD is read by the disc loader 4 and supplied to the DVD decoder 8 as the audio serial data via the selector 7. The DVD decoder 8 carried out its sound decoding, and the decoded data is subjected to the analog conversion by the audio DAC 11 and output from the speaker 3.

The conventional external input audio processor has the foregoing configuration. Thus, as for the CD input data, the DVD decoder 8 is designed to accept only the audio serial data supplied from the disc loader 4 without the CD input as the external input in mind.

Therefore, to accept the analog input or the external digital audio data input such as the IEC958 input, it is necessary for the DVD decoder 8 to have external circuitry such as the audio ADC 5 for converting the analog input to the digital data, the DIR 6 for carrying out the format conversion of the IEC958 input, and the selector 7 for selecting one of the audio serial data, digital data and digital audio data passing through the format conversion by the DIR 6.

Although the DVD decoder 8 consists of a semiconductor chip, the audio ADC 5, DIR 6 and selector 7 are provided outside the DVD decoder 8, offering a problem of increasing the circuit scale.

### SUMMARY OF THE INVENTION

The present invention is implemented to solve the foregoing problem. It is therefore an object of the present invention to provide an external input audio processor capable of reducing the circuit scale of the system.

According to a first aspect of the present invention, there is provided an external input audio processor including: first to third input terminals for inputting an audio stream, audio serial data and digital audio serial data; a selector for selecting one of the digital data supplied from theses input terminals; and an audio processing circuit for carrying out audio processing of the digital data selected by the selector. Thus, the external input audio processor can obviate the external selector because it includes the selector in itself. Since the external input audio processor consists of a semiconductor chip, it offers an advantage of being able to reduce the circuit scale by using the built-in selector rather than by using the external selector.

According to a second aspect of the present invention, there is provided an external input audio processor including first to third input terminals for inputting an audio stream, audio serial data, and an analog input and/or external digital audio data; converting means for converting the analog input and/or digital audio data to prescribed digital data; a selector for selecting one of the digital data supplied from the first input terminal, the second input terminal and the converting means; and an audio processing circuit for carrying out audio processing of the digital data selected by the selector. Thus, the external input audio processor can obviate the external converting means such as an analog-to-digital converter and digital interface receiver and the external selector because it includes them in itself. Since the external input audio processor consists of a semiconductor chip, it offers an advantage of being able to reduce the circuit scale by using the built-in analog-to-digital converter, digital interface receiver and selector rather than by using their external counterparts.

### BRIEF DESCRIPTION OF THE DRAWINGS

FIG. 1 is a block diagram showing a configuration of a DVD system with a built-in external input audio processor of an embodiment 1 in accordance with the present invention;

FIGS. 2A-2C are diagrams illustrating various formats of an audio serial format;

FIG. 3 is a block diagram showing a configuration of a DVD system with a built-in external input audio processor of an embodiment 2 in accordance with the present invention;

FIG. 4 is a block diagram showing a configuration of a DVD system with a built-in external input audio processor of an embodiment 3 in accordance with the present invention;

FIG. 5 is a block diagram showing a configuration of a DVD system with a built-in external input audio processor of an embodiment 4 in accordance with the present invention;

FIG. 6 is a block diagram showing a configuration of a DVD system with a built-in external input audio processor of an embodiment 5 in accordance with the present invention;

FIG. 7 is a block diagram showing a configuration of a DVD system with a built-in external input audio processor of an embodiment 6 in accordance with the present invention; and

FIG. 8 is a block diagram showing a configuration of a conventional DVD system with a built-in external input audio processor.

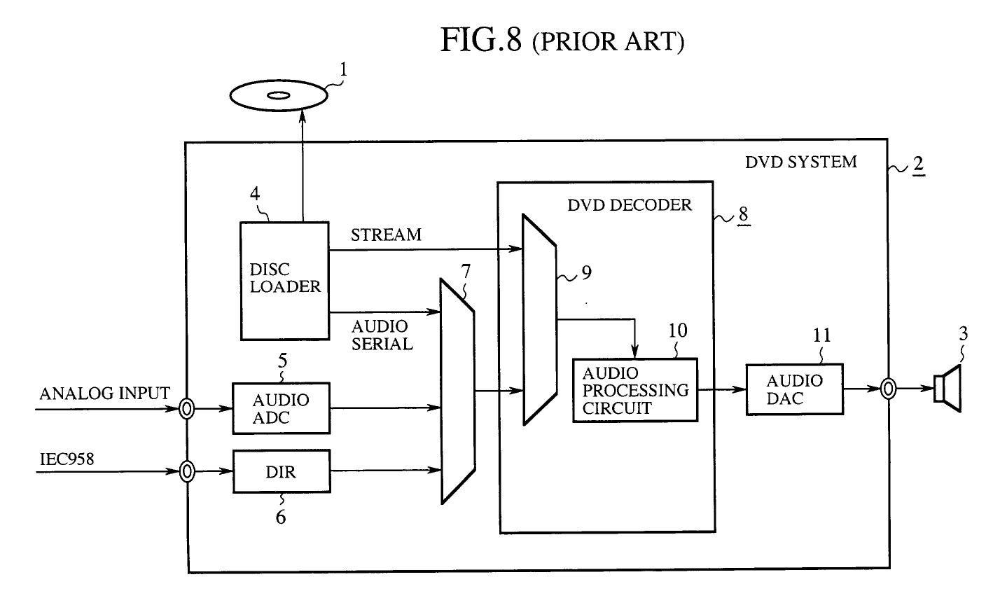

### DETAILED DESCRIPTION OF THE PREFERRED EMBODIMENTS

The invention will now be described with reference to the accompanying drawings.

Embodiment 1

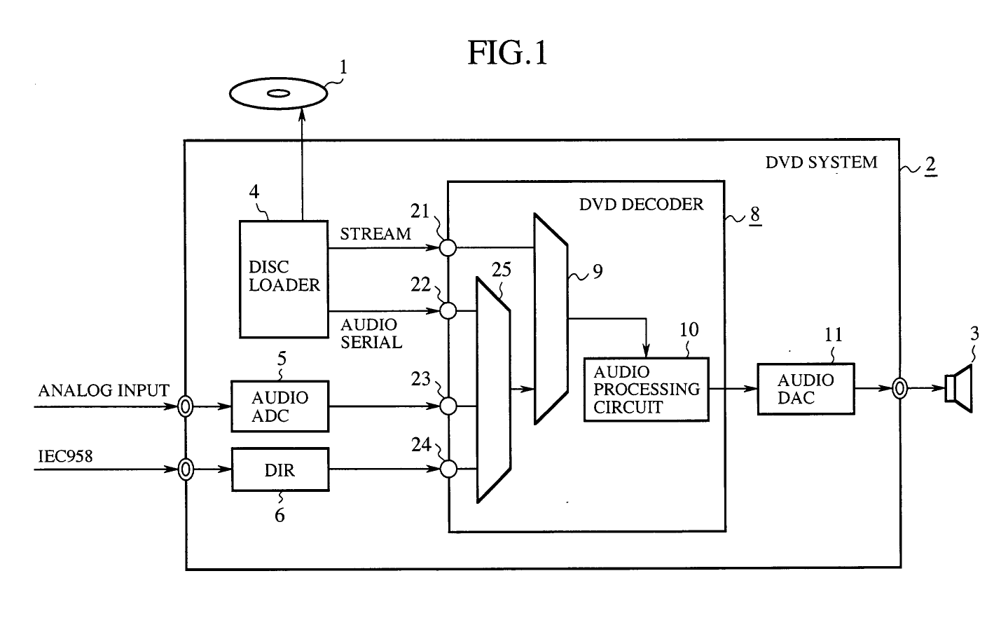

FIG. 1 is a block diagram showing a configuration of a DVD system with a built-in external input audio processor of an embodiment 1 in accordance with the present invention. In this figure, the reference numeral 1 designates a DVD (Digital Video Disc), 2 designates a DVD system and 3 designates a speaker.

In the DVD system 2, the reference numeral 4 designates a disc loader that reads data from the DVD 1 and converts the data to an audio stream to be output, or reads data from a CD (Compact Disc) and converts the data to audio serial data to be output; 5 designates an audio ADC (Analog-to-Digital Converter) that carries out analog-to-digital conversion of an analog input and outputs digital data; and 6 designates a DIR (Digital Interface Receiver) for carrying out format conversion of external digital audio data such as an IEC958 input.

The reference numeral 8 designates a DVD decoder (external input audio processor) composed of a semiconductor chip for isolating the stream read from the DVD 1 and supplied from the disc loader 4, and for carrying out the image decoding and sound decoding of the stream. In the DVD decoder 8, the reference numeral 21 designates an input terminal (first terminal) for inputting the audio stream from the disc loader 4; 22 designates an input terminal (second terminal) for inputting the audio serial data from the disc loader 4; 23 designates an input terminal (third terminal) for inputting the digital data from the audio ADC 5; and 24 designates an input terminal (third terminal) for inputting the digital audio data from the DIR 6. The reference numeral 25 designates a selector that selects one of the audio serial data, digital data and digital audio data passing through the format conversion by the DIR 6, and outputs the selected data; 9 designates a selector for selecting one of the digital data supplied from the disc loader 4 and selector 25; and 10 designates an audio processing circuit for carrying out audio processing of the digital data selected by the selector 9.

The reference numeral 11 designates an audio DAC that carries out the digital-to-analog conversion of the digital data passing through the audio processing and supplies the analog data to the speaker 3.

Next, the operation of the present embodiment 1 will be described.

In FIG. 1, the stream on the DVD 1 or video CD is read by the disc loader 4 and supplied to the DVD decoder 8 via the input terminal 21.

On the other hand, the CD data is supplied from the disc loader 4 to the DVD decoder 8 via the input terminal 22 as the audio serial data.

In addition, the analog input from a device such as a microphone is subjected to the analog-to-digital conversion by the audio ADC 5, and is supplied to the DVD decoder 8 via the input terminal 23.

Furthermore, the external digital audio data input such as the IEC958 input is subjected to the format conversion by the DIR 6, and is supplied to the DVD decoder 8 via the input terminal 24.

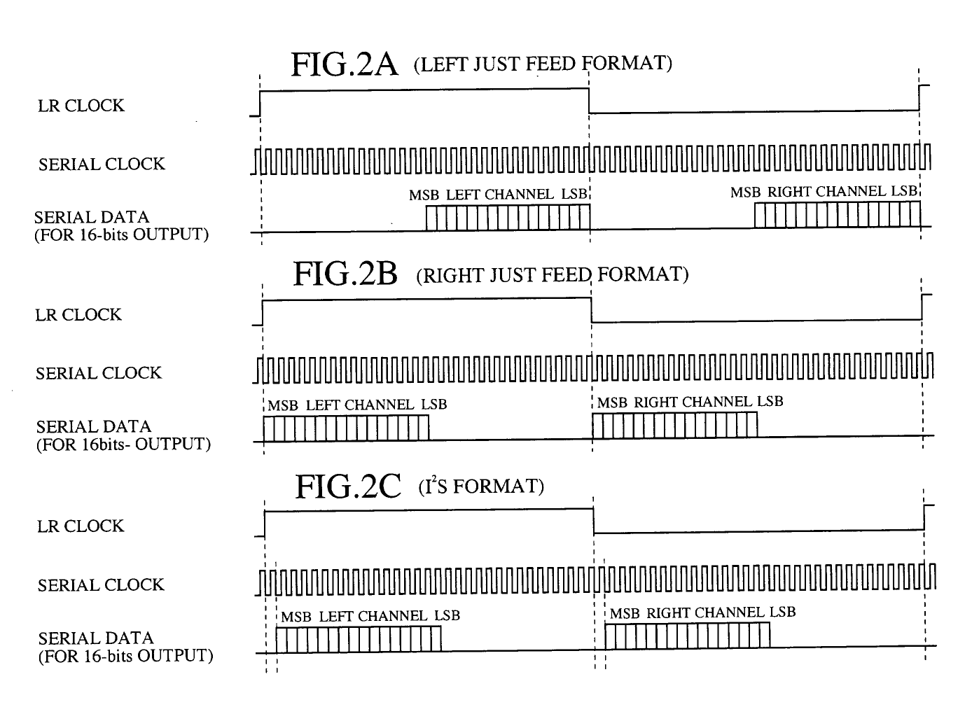

FIGS. 2A-2C are diagrams illustrating various audio serial formats. In this figure, the audio serial data is one of the data formats that includes three lines consisting of a channel clock (LR clock), a serial clock and serial data.

FIG. 2A illustrates a left-just feed format, FIG. 2B illustrates a right-just feed format and FIG. 2C illustrates an 12S format. Thus, although the audio serial format includes multiple formats, the audio ADC 5 or the DIR 6 is not necessarily compatible with the audio serial formats.

In view of this, the audio serial formats of the input terminals 23 and 24 of the DVD decoder 8 are determined such that those input terminals can accept the formats as illustrated in FIGS. 2A-2C, for example.

With such a configuration, if the input terminals 23 and 24 each match with only a particular format, a format conversion means is required to match the output formats of the audio ADC 5 and DIR 6 with the formats of the input terminals 23 and 24. However, since the input terminals 23 and 24 can accept the various formats in the present embodiment 1, it is not necessary to match the output formats of the audio ADC 5 and DIR 6 to the formats of the input terminals 23 and 24, thereby obviating the need for the format conversion means.

In FIG. 1, the selector 25 selects one of the audio serial data, digital data and digital audio data passing through the format conversion, which are supplied from the input terminals 22-24. The selector 9 selects one of the audio stream supplied from the disc loader 4 via the input terminal 21 and the digital data selected by the selector 25, and supplies the selected data to the audio processing circuit 10.

The DVD decoder 8 of the present embodiment 1 includes four input terminals 21-24 and the selector 25, thereby making it possible to remove the selector 7 which is connected outside the DVD decoder in the conventional system. In addition, since the DVD decoder 8 consists of a semiconductor chip, the present embodiment 1 can reduce the circuit scale of the system as compared with the conventional system by integrating the selector 25 in the chip rather than by connecting the selector 7 outside.

Although the present embodiment 1 includes the four input terminals 21-24, this is not essential. For example, it is possible to omit the input terminal 23 for inputting the digital data from the audio ADC 5, or the input terminal 24 for inputting the digital audio data from the DIR 6.

Furthermore, the present embodiment is applicable to a configuration including more than four input terminals 21-24.

In FIG. 1, the digital data selected by the selector 9 is output from the speaker 3 after passing through the audio processing by the audio processing circuit 10, and the analog conversion by the audio DAC 11.

Embodiment 2

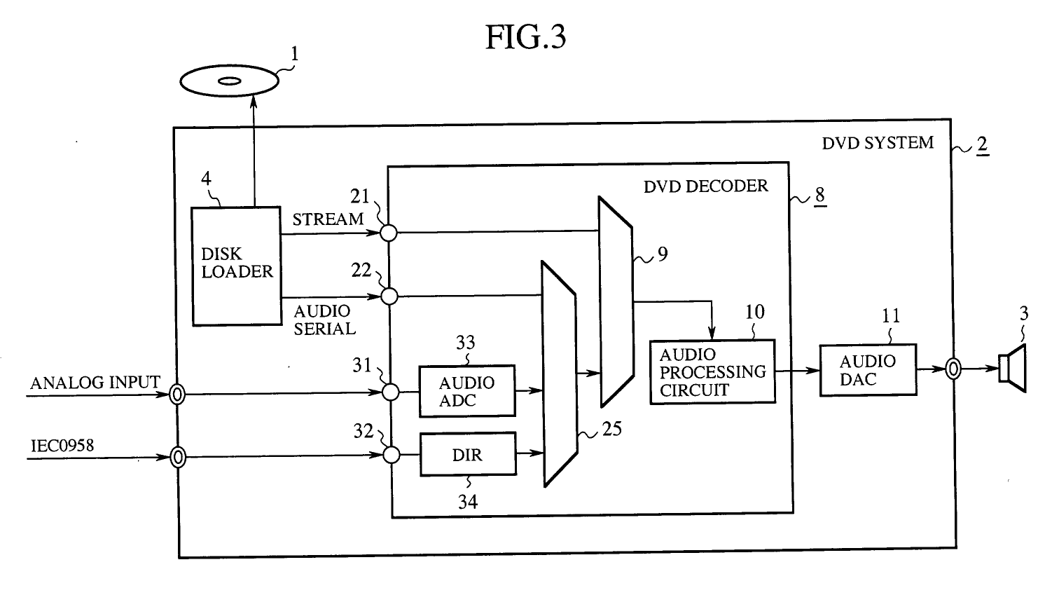

FIG. 3 is a block diagram showing a configuration of the DVD system with a built-in external input audio processor of an embodiment 2 in accordance with the present invention. In the DVD decoder 8, the reference numeral 31 designates an input terminal (third input terminal) for inputting an analog input; and 32 designates an input terminal (fourth input terminal) for inputting the external digital audio data such as an IEC958 input. The reference numeral 33 designates an audio ADC that carries out the analog-to-digital conversion of the analog input supplied from the input terminal 31, and outputs the digital data; and 34 designates a DIR for making the format conversion of the external digital audio data such as an IEC958 input.

The remaining configuration is the same as that of FIG. 1.

Next, the operation of the present embodiment 2 will be described.

The DVD decoder 8 as shown in FIG. 3 comprises, as the analog input line, the input terminal 31 including four terminals (AINL+, AINL−, AINR+, AINR−) for two-channel analog inputs, and the audio ADC 33 that carries out the analog-to-digital conversion of the analog input supplied via the input terminal 31, and outputs the digital data.

In addition, the DVD decoder 8 comprises, as the IEC958 input line, the input terminal 32 having one terminal for the digital audio data, and the DIR 34 for converting the digital audio data supplied via the input terminal 32 to the audio serial data.

Furthermore, it comprises the selector 25 for selecting one of the digital data supplied from the input terminal 22, audio ADC 33 and DIR 34.

Unlike the conventional technique comprising the audio ADC 5, DIR 6 and selector 7 which are externally connected to the DVD decoder 8, the DVD decoder 8 of the present embodiment 2 includes them so that it can obviate the need for the external audio ADC 5, DIR 6 and selector 7. In addition, since the DVD decoder 8 consists of a semiconductor chip, the present embodiment 2 can reduce the circuit scale of the system as compared with the conventional system by integrating the audio ADC 33, DIR 34 and selector 25 in the chip rather than by connecting the audio ADC 5, DIR 6 and selector 7 outside.

Although the present embodiment 2 is described by way of example of the configuration including the input terminal 31 and audio ADC 33, and the input terminal 32 and DIR 34, a configuration without one of the two pairs is also applicable.

Furthermore, the present embodiment 2 is applicable to a configuration including more than four input terminals 21-24.

Embodiment 3

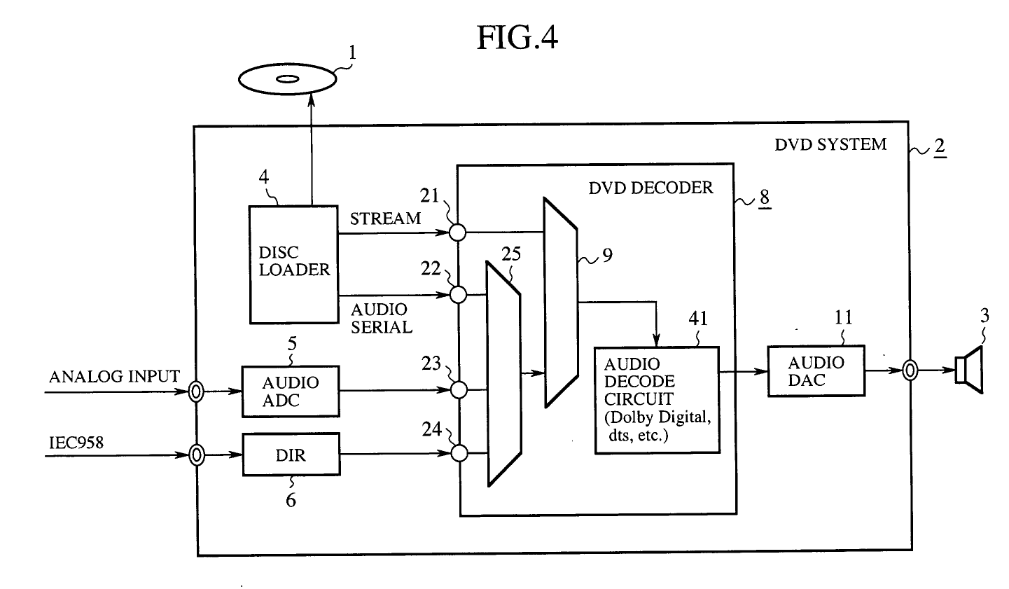

FIG. 4 is a block diagram showing a configuration of a DVD system with a built-in external input audio processor of an embodiment 3 in accordance with the present invention. In the DVD decoder 8, the reference numeral 41 designates an audio decode circuit for carrying out the audio decoding.

The remaining configuration is the same as that of FIG. 1.

Next, the operation of the present embodiment 3 will be described.

There are CD-DTS (Digital Theater System) and CD-Dolby Digital that use the CD data as audio stream data rather than as sound PCM data. In this case, it is necessary to decode the audio stream.

In the present embodiment 3, the audio decode circuit 41 carries out the audio decoding. Accordingly, it can achieve the decoding of the Dolby Digital, MPEG audio, DTS, WMA (Windows Media Audio) and the like.

Embodiment 4

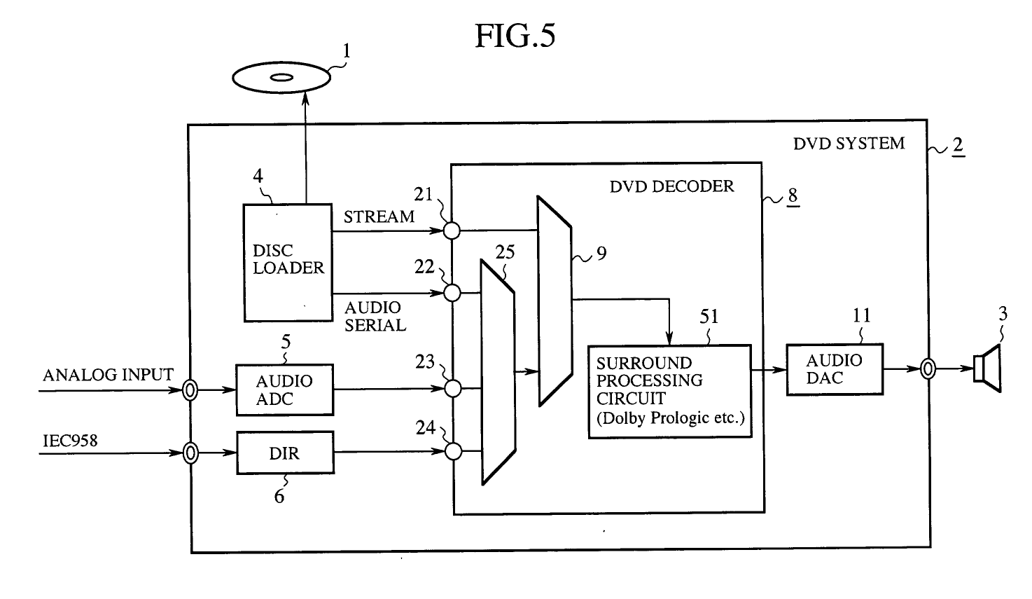

FIG. 5 is a block diagram showing a configuration of the DVD system with a built-in external input audio processor of an embodiment 4 in accordance with the present invention. In the DVD decoder 8, the reference numeral 51 designates a surround processing circuit for carrying out surround processing.

The remaining configuration is the same as that of FIG. 1.

Next, the operation of the present embodiment 4 will be described.

Although ordinary CD data are two-channel sound PCM data, there is surround processing that converts the two-channel data, and outputs three-or-more-channel sound.

The present embodiment 4 includes the surround processing circuit 51 for carrying out such surround processing. Thus, it can carry out the surround processing such as Dolby Prologic, Prologic II and the like.

Embodiment 5

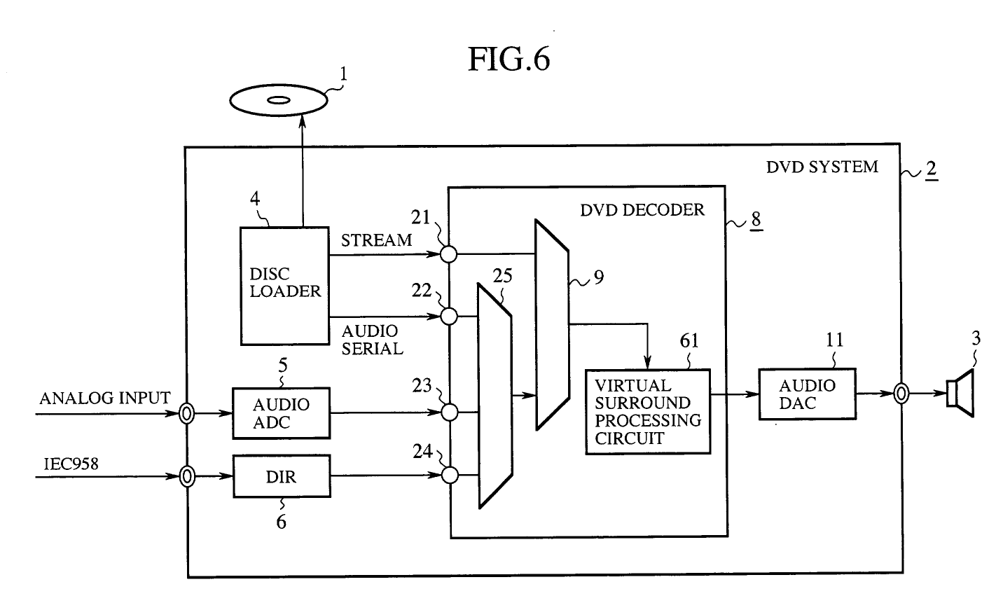

FIG. 6 is a block diagram showing a configuration of the DVD system with a built-in external input audio processor of an embodiment 5 in accordance with the present invention. In the DVD decoder 8, the reference numeral 61 designates a virtual surround processing circuit for carrying out virtual surround processing.

The remaining configuration is the same as that of FIG. 1.

Next, the operation of the present embodiment 5 will be described.

There is an audio enhancement function such as virtual surround processing in the audio processing. The virtual surround processing converts the ordinary two-channel CD data to the output sound achieving virtual surround effect with two channels.

Thus, the present embodiment 5 includes the virtual surround processing circuit 61 for carrying out the virtual surround processing. Accordingly, it can achieve the virtual surround processing such as SRS3D (Sound Retrieval System 3-D) audio enhancement signal processing and the like.

Embodiment 6

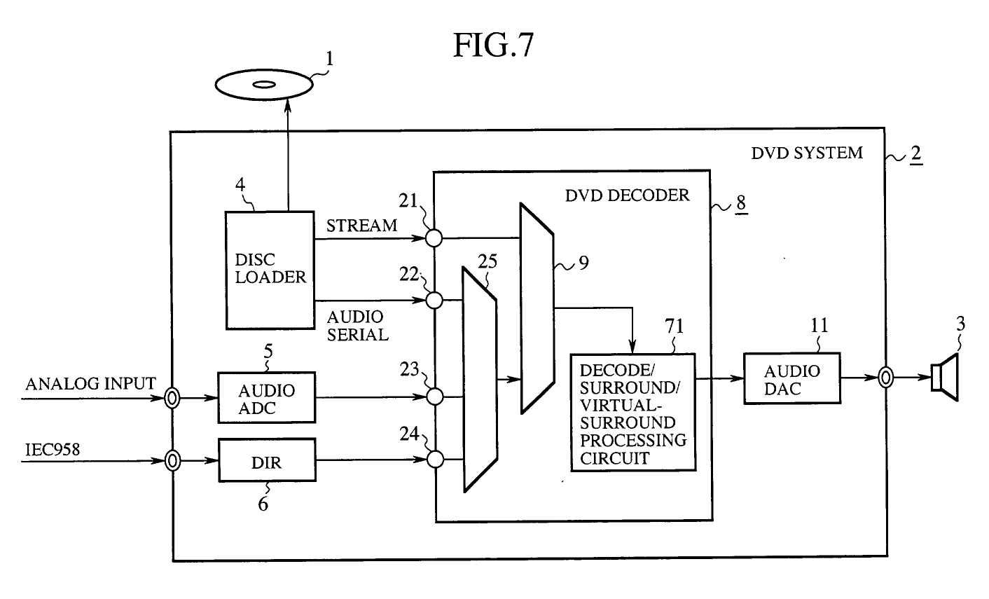

FIG. 7 is a block diagram showing a configuration of the DVD system with a built-in external input audio processor of an embodiment 6 in accordance with the present invention. In the DVD decoder 8, the reference numeral 71 designates a decode/surround/virtual-surround processing circuit for carrying out the surround processing or virtual surround processing after the audio decoding.

The remaining configuration is the same as that of FIG. 1.

Next, the operation of the present embodiment 6 will be described.

The present embodiment 6 is configured such that the decode/surround/virtual-surround processing circuit 71 performs the surround processing or virtual surround processing after the audio decoding. Accordingly, it can achieve the audio enhancement processing in the surround processing or virtual surround processing after the audio decoding.

What is claimed is:

1. An external input audio processor comprising:
a first input terminal for inputting an audio stream;
a second input terminal for inputting audio serial data;
a third input terminal for inputting digital audio serial data;
a selector for selecting one of the digital data supplied from said first to third input terminals; and
an audio processing circuit for carrying out audio processing of the digital data selected by said selector.

2. The external input audio processor according to claim 1, wherein said third input terminal is compatible with various audio serial formats.

3. An external input audio processor comprising:
a first input terminal for inputting an audio stream;
a second input terminal for inputting audio serial data;
a third input terminal for inputting at least one of an analog input and external digital audio data;
converting means for carrying out analog-to-digital conversion of the analog input when the input to said third input terminal is the analog input, and for carrying out format conversion of the digital audio data when the input to said third input terminal is the digital audio data;
a selector for selecting one of the digital data supplied from said first input terminal, said second input terminal and said converting means; and
an audio processing circuit for carrying out audio processing of the digital data selected by said selector.

4. The external input audio processor according to claim 1, wherein said audio processing circuit consists of an audio decode circuit for carrying out audio decoding as the audio processing.

5. The external input audio processor according to claim 1, wherein said audio processing circuit consists of a surround processing circuit for carrying out surround processing as the audio processing.

6. The external input audio processor according to claim 1, wherein said audio processing circuit consists of a virtual surround processing circuit for carrying out virtual surround processing as the audio processing.

7. The external input audio processor according to claim 1, wherein said audio processing circuit consists of a decode/surround/virtual-surround processing circuit for carrying out as the audio processing one of surround processing and virtual surround processing after audio decoding.

8. The external input audio processor according to claim 1, further comprising a fourth input terminal for inputting external digital audio data, wherein said selector selects one of the digital data supplied from said first to fourth input terminals.

9. The external input audio processor according to claim 3, wherein said third input terminal comprises an input terminal for inputting the analog input, and an input terminal for inputting the external digital audio data; and said converting means comprises an analog-to-digital converter for converting the analog input digital data, and a digital interface receiver for carrying out the format conversion of the digital audio data, and wherein said selector selects one of the digital data supplied from said first input terminal, said second input terminal, said analog-to-digital converter and said digital interface receiver.

10. The external input audio processor according to claim 4, wherein said audio decode circuit carries out the audio decoding in accordance with Dolby Digital, MPEG audio, DTS (Digital Theater System) and WMA (Windows Media Audio).

11. The external input audio processor according to claim 5, wherein said surround processing circuit carries out the surround processing in accordance with Dolby Prologic and Dolby Prologic II.

12. The external input audio processor according to claim 6, wherein said virtual surround processing circuit carries out the virtual surround processing in accordance with SRS3D (Sound Retrieval System 3-D) audio enhancement signal processing.

13. The external input audio processor according to claim 1, wherein said external input audio processor is integrated into a semiconductor chip.

14. The external input audio processor according to claim 3, wherein said external input audio processor is integrated into a semiconductor chip.
